(19) United States
(12) Patent Application Publication
(10) Pub. No.: US 2011/0134302 A1
(43) Pub. Date: Jun. 9, 2011

(54) System, Device, and Method for Displaying Message

(75) Inventors: Chia-Hsun Wu, Taipei (TW); Chih-Wen Hsieh, Taipei (TW); Zamudio Sanchez Alejandro, Taipei (TW)

(73) Assignee: PEGATRON CORPORATION, Taipei (TW)

(21) Appl. No.: 12/949,875

(22) Filed: Nov. 19, 2010

(30) Foreign Application Priority Data
Dec. 3, 2009 (TW) 098141356

(51) Int. Cl. H04N 5/225; G09G 5/00; G06F 3/041

(52) U.S. Cl. 348/333.02; 345/3.1; 345/173; 348/E05.024

(57) ABSTRACT

A system for displaying a message includes a first electronic device and a second electronic device. The first electronic device includes a touch module, a first projection module, a first positioning module, and a first transceiving module. The touch module receives a touch signal and generates a first image data; the first projection module projects the first image data; the first positioning module provides a first positioning data according to a location of the first electronic device; the first transceiving module transmits a first message including the first positioning data and the first image data. The second electronic device includes a second transceiving module and a second projection module. The second transceiving module receives the first message; the second projection module projects the first image data. Therefore, the system for displaying a message presents the first image data in a specific condition.

### CROSS-REFERENCE TO RELATED APPLICATIONS

This Non-provisional application claims priority under 35 U.S.C. §119(a) on Patent Application No(s). 098141356 filed in Taiwan, Republic of China on Dec. 3, 2009, the entire contents of which are hereby incorporated by reference.

### BACKGROUND OF THE INVENTION

1. Field of the Invention

This invention relates to a display system, a display device, and a display method and, more particularly, to a system, a device, and a method for displaying a message.

2. Description of the Related Art

Besides conversation face to face, the memory between people also includes events and surrounding environments. An event happened at a specific date and a specific place is worth remembering.

One transmitting an idea and one receiving the idea may fail to look back a happened event at a specific place at the same time. At that moment, if the receiving one is guided to the specific place and see specific signs via the message, an effect of recalling past memories or creating memories can be achieved.

### BRIEF SUMMARY OF THE INVENTION

One objective of this invention is to provide a system, a device, and a method for displaying a message to project a first image data in a projection mode, thereby allowing the first image data to be lively and interestingly presented.

One objective of the invention is to provide a system, a device, and a method for displaying a message. The first image data is just transmitted to a specific device, and the first image data is played after the specific device reaches a location corresponding to a first positioning data, thereby allowing a specific message to be expressed at a specific place.

To achieve the above objective, the embodiment of this invention provides a system for displaying a message including a first electronic device and a second electronic device. The first electronic device includes a touch module, a first projection module, a first positioning module, and a first transceiving module. The touch module receives a touch signal and generates a first image data according to the touch signal. The first projection module is used for projecting the first image data. The first positioning module provides a first positioning data according to a location of the first electronic device. The first transceiving module is used for transmitting a first message including the first positioning data and the first image data. The second electronic device includes a second transceiving module, a second projection module, and a second positioning module. The second transceiving module is used for receiving the first message. The second projection module is used for projecting the first image data. The second positioning module provides a second positioning data according to a location of the second electronic device. When the first positioning data matches the second positioning data, the second projection module projects the first image data.

In one embodiment of the invention, the second transceiving module may simultaneously or nonsimultaneously receive the first positioning data and the first image data.

In one embodiment of the invention, the second transceiving module may first receive the first positioning data. When the second electronic device is moved to the location corresponding to the first positioning data, the second transceiving module may receive the first image data, and the second projection module of the second electronic device may project the first image data.

In one embodiment of the invention, the second transceiving module may simultaneously receive the first positioning data and the first image data. When the second electronic device is moved to the location corresponding to the first positioning data, the second projection module of the second electronic device may project the first image data.

To achieve the above objective, the embodiment of this invention provides a message-displaying method for displaying a first image data of a first message. The first message includes a first positioning data and the first image data. The method includes the following steps. A second positioning data is provided. The first positioning data is compared with the second positioning data. When the first positioning data matches the second positioning data, the first image data is projected.

In one embodiment of the invention, the method may further include the following steps. A touch signal may be received and a second image data may be generated according to the touch signal; the second image data may be projected; a second message including the second positioning data and the second image data may be transmitted.

To achieve the above objective, the embodiment of this invention provides a message-displaying device for displaying a first image data of a first message. The first message includes a first positioning data and the first image data, and the device includes a projection module, a positioning module, and a processing module. The projection module is used for projecting the first image data. The positioning module provides a second positioning data according to a location of the device for displaying a message. The processing module is used for comparing the first positioning data with the second positioning data. When the first positioning data matches the second positioning data, the projection module projects the first image data.

In one embodiment of the invention, the device for displaying a message may further include a touch module receiving a touch signal and generating a second image data according to the touch signal.

In one embodiment of the invention, the device for displaying a message may further include a transceiving module for receiving the first message and transmitting a second message including the second positioning data and the second image data.

According to the above, the invention discloses a system, a device, and a method for displaying a message. The first electronic device, i.e. a transmitting terminal, generates a first image data, such as photograph scrawl, drawing scrawl, or a text message and so on, according to a touch signal inputted by a user at the touch module and generates a first positioning data according to a location where the first electronic device generates the first image data. Therefore, besides using the first projection module of the first electronic device to project the first image data, the user may also transmit the first image data and the first positioning data to the second electronic device, i.e. a receiving terminal, in a wireless transmission mode, such that the first image data can be played after a specific person reaches the location corresponding to the first positioning data. That is, the specific person cannot see the first image data until he or she substantially stays at the place where the first electronic device generates the first image data, thereby allowing the specific message to be expressed at the specific place.

Thereby, since the first image data is presented in a projection mode, the first image data is lively and interestingly presented, and an environment landscape is prevented from being damaged. In addition, a place where the first image data is projected is assigned via the first positioning data, the first image data and the surrounding environment will be combine to generate more changes.

These and other features, aspects, and advantages of the present invention will become better understood with regard to the following description, appended claims, and accompanying drawings.

### BRIEF DESCRIPTION OF THE DRAWINGS

FIG. 1 is a schematic diagram showing a system for displaying a message according to one preferred embodiment of the invention;

FIG. 2A is a schematic diagram showing a first electronic device in a using state according to one preferred embodiment of the invention;

FIG. 2B is a schematic diagram showing a second electronic device in a using state according to one preferred embodiment of the invention;

FIG. 3 is a schematic diagram showing a system for displaying a message in another form according to one preferred embodiment of the invention;

FIG. 4 is a schematic diagram showing a system for displaying a message in another form according to one preferred embodiment of the invention; and

FIG. 5 is a flowchart showing a method for displaying a message according to one preferred embodiment of the invention.

### DETAILED DESCRIPTION OF THE INVENTION

A system, a device, and a method for displaying a message in preferred embodiments of this invention are described according to related figures, and the same elements are marked by the same reference numbers.

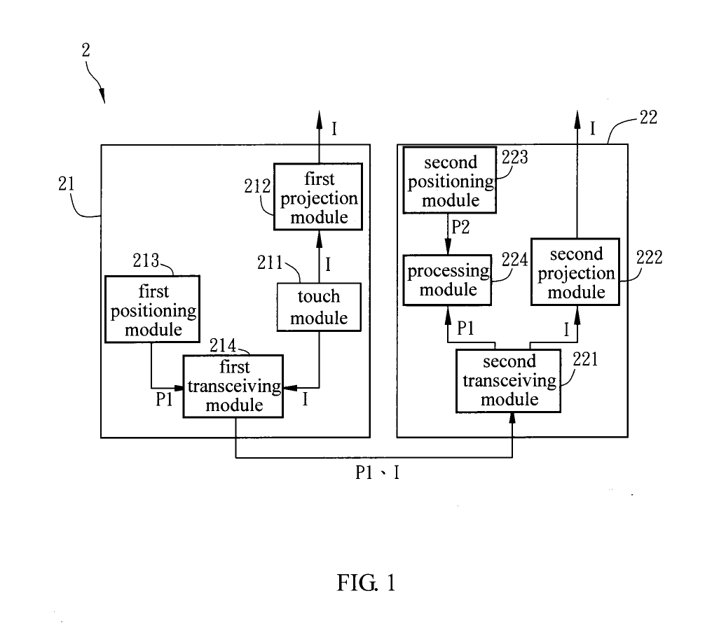

FIG. 1 is a schematic diagram showing a system for displaying a message according to one preferred embodiment of the invention. In FIG. 1, a system for displaying a message 2 includes a first electronic device 21 and a second electronic device 22. The first electronic device 21 and the second electronic device 22 may be a personal digital assistant (PDA), a mobile communication device, a notebook computer, a global position system (GPS), a portable game machine, a digital still camera (DSC), or an e-Book, respectively.

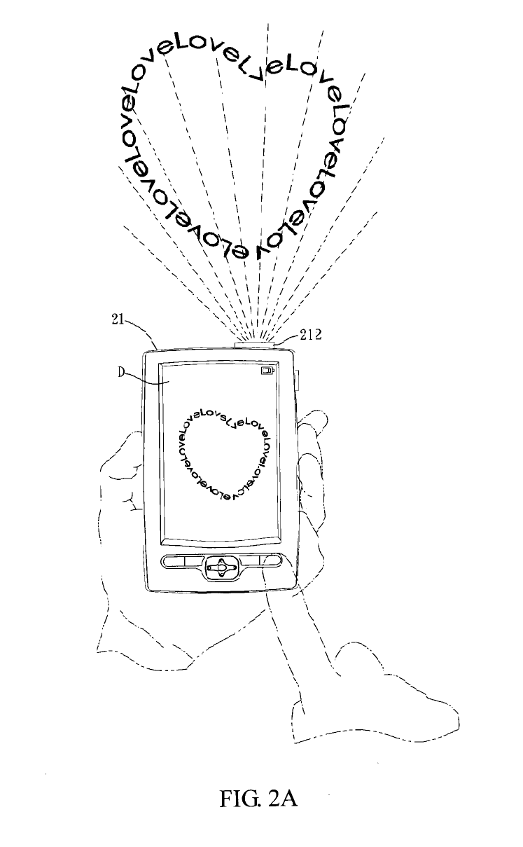

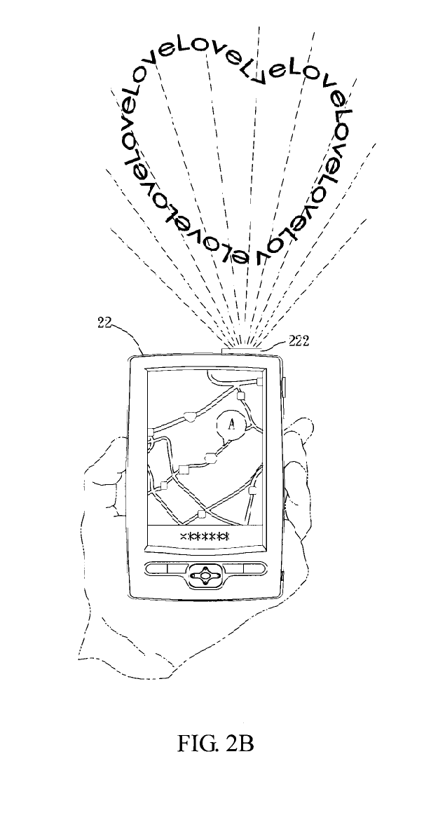

Please refer to FIG. 1 and FIG. 2A together. FIG. 2A is a schematic diagram showing the first electronic device in a using state. The first electronic device 21 includes a touch module 211, a first projection module 212, a first positioning module 213, and a first transceiving module 214. The first positioning module 213 is coupled with the first transceiving module 214, and the touch module 211 is coupled with the first projection module 212 and the first transceiving module 214.

The touch module 211 includes a touch panel D, and the touch module 211 receives a touch signal generated by operation of a user. In other words, the user may write characters, scrawl photographs, or scrawl drawings on the touch panel D, and the touch module 211 can generate a first image data I according to the characters written by the user, the photographs, or the drawings scrawled by the user.

The first projection module 212 is coupled with the touch module 211, and the first projection module 212 receives the first image data I generated by the touch module 211. Further, the user may project the first image data I on a surrounding environment, such as a wall, a platy object, or other environments, via the first projection module 212.

When the first projection module 212 projects the first image data I, the first positioning module 213 generates a first positioning data P1 according to a location of the first electronic device 21. The first positioning module 213 may include a global position system (GPS), and the global position system obtains a coordinate of a receiving device by receiving signals transmitted by a satellite and cooperating with geometrical calculation to provide an accurate location data. In addition, the first positioning data P1 may be a coordinate including longitude and latitude or a map data.

The first transceiving module 214 is coupled with the touch module 211 and the first positioning module 213, and it may transmit a first message including the first positioning data P1 and the first image data I in a wired or wireless transmission mode. In the embodiment, the wireless transmission mode is taken for example. However, the invention is not limited thereto. The wireless transmission mode may be frequency modulation (FM) transmission, radio frequency identification (RFID) transmission, Bluetooth transmission, infrared transmission, or a global system for mobile communication (GSM). However, the invention is not limited thereto. In addition, the first transceiving module 214 in the embodiment may have a receiving function and may receive data transmitted by other electronic devices.

Therefore, the user may write characters, scrawl photographs, or scrawl drawings on the touch panel D of the first electronic device 21 and allow the characters, photographs, or drawings to be projected on the surrounding environment, such as a wall, a platy object, or other environments. Further, the first image data I and the first positioning data P1 indicating the location of the first electronic device 21 are transmitted to the second electronic device 22.

Please refer to FIG. 1 and FIG. 2B. FIG. 2B is a schematic diagram showing the second electronic device in a using state. The second electronic device 22 includes a second transceiving module 221, a second projection module 222, a second positioning module 223, and a processing module 224. The second transceiving module 221 is coupled with the second projection module 222, and the processing module 224 is coupled with the second transceiving module 221 and the second positioning module 223.

The second transceiving module 221 may receive the first message in a wireless transmission mode. The wireless transmission mode may correspond to the frequency modulation (FM) transmission, the radio frequency identification (RFID) transmission, the Bluetooth transmission, the infrared transmission, or the global system for mobile communication (GSM) used by the first transceiving module 214 of the first electronic device 21. In addition, the second transceiving module 221 in the embodiment may also have a transmitting function and transmit data to other electronic devices.

The second transceiving module 221 may simultaneously or nonsimultaneously receive the first positioning data P1 and the first image data I. The nonsimultaneous reception is that the second transceiving module 221 first receives the first positioning data P1 and then receives the first image data I, or the second transceiving module 221 first receives the first image data I and then receives the first positioning data P1. In other words, the second transceiving module 221 may receive the first positioning data P1 and the first image data I in order or receive the first image data I and the first positioning data P1 in order. However, the invention is not limited thereto. In the embodiment, that the second transceiving module 221 simultaneously receiving the first positioning data P1 and the first image data I is taken for example. However, the invention is not limited thereto.

The second projection module 222 is coupled with the second transceiving module 221, receives the first image data I, and projects the first image data I on a wall or a platy object.

The second positioning module 223 generates a second positioning data P2 according to a location of the second electronic device 22. The second positioning module 223 may include a global position system (GPS), and the global position system obtains a coordinate of a receiving device by receiving signals transmitted by a satellite and cooperating geometrical calculation to provide an accurate location data.

Therefore, after the second transceiving module 221 of the second electronic device 22 simultaneously receives the first positioning data P1 and the first image data I, and the second electronic device 22 is moved to the location corresponding to the first positioning data P1, i.e. a location A in FIG. 2B, by the user, the second electronic device 22 will display the first image data I and project the first image data I via the second projection module 222. In other words, a transmitter may hold and operate the first electronic device 21 at the location A, and he or she scrawl via the touch panel D of the touch module 211 to generate the first image data I. Then, the transmitter projects the first image data I on a surrounding environment, such as a wall, a platy object, or other environments, via the first projection module 212.

In addition, the first positioning module 213 generates the first positioning data P1 according to the location of the first electronic device 21, i.e. the location A. If the transmitter want to share the first image data I with others, he or she may transmit the first image data I and the first positioning data P1 corresponding to the location A to the second electronic device 22 held by a receiver via the first transceiving module 214 in a wireless transmission mode.

After the second transceiving module 221 of the second electronic device 22 of the receiver simultaneously receives the first positioning data P1 and the first image data I, the longitude and latitude coordinate or the map data of the first positioning data P1 are read. However, if the second electronic device 22 is not located at the location A, the second electronic device 22 of the receiver fails to read the first image data I. At that moment, the second electronic device 22 may display a message to indicate the receiver that the received first image data I may only be read at the location A corresponding to the first positioning data P1.

Therefore, the receiver has to hold and move the second electronic device 22 to the location A corresponding to the first positioning data P1 according to the longitude and latitude coordinate or the map data of the first positioning data P1. During a moving process of the second electronic device 22, the processing module 224 compares the second positioning data P2 to which the location of the second electronic device 22 corresponds and the first positioning data P1. When the second positioning data P2 matches the first positioning data P1, the second electronic device 22 of the receiver will read and project the first image data I on the surrounding environment, such as a wall, a platy object, or other environments.

In the embodiment, the second positioning data P2 of the second electronic device 22 may be substantially equal to the first positioning data P1 of the first electronic device 21. Further, since precision errors of the positioning data, a deviation may be 200 meters or be within other set error ranges, which all belongs to the match called in the embodiment.

In addition, the first electronic device 21 in the embodiment can further include an image capturing module (not shown) coupled with the first projection module 212 and the first transceiving module 214. However, the invention is not limited thereto. The image capturing module may capture an image data at the location of the first electronic device 21. The image data may be photographs of the environment location where the first image data I is to be projected. The first transceiving module 214 of the first electronic device 21 transmits the image data and the first message including the first positioning data P1 and the first image data Ito the second electronic device 22, such that when the user holding the second electronic device 22 moves to the location where the first electronic device 21 generates the first image data I, the user will know where the first image data I has to be projected, such as, on which one of walls.

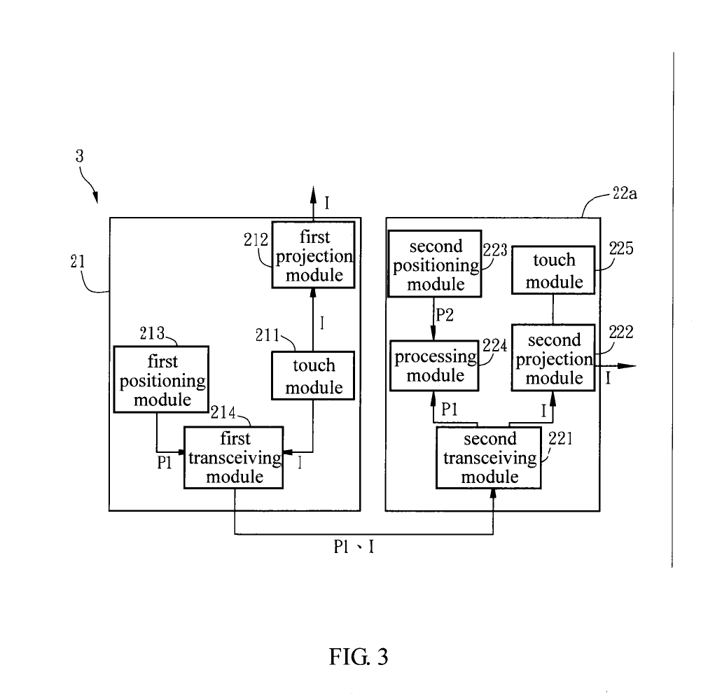

FIG. 3 is a schematic diagram showing a system for displaying a message in another form according to one preferred embodiment of the invention. In FIG. 3, a second electronic device 22a of a system 3 for displaying a message further includes a touch module 225 coupled with a second projection module 222.

A receiver may control operation of the second electronic device 22a via the touch module 225 of the second electronic device 22a. For example, the receiver controls a first image data I to be enlarged or reduced, and the receiver may also write characters, scrawl photographs, or scrawl drawings on the touch module 225 to generate a second image data. That is, the touch module 225 receives a touch signal generated by the operation of the receiver further to generate the second image data. A first electronic device 21 and the second electronic device 22a may be electronic devices with the same functions or with partial different functions.

In the embodiment, the second electronic device 22a may include two receiving modes. The first receiving mode is that a second transceiving module 221 of the second electronic device 22a simultaneously receives a first positioning data P1 and the first image data I transmitted by the first electronic device 21. The second receiving mode is that the second transceiving module 221 of the second electronic device 22a nonsimultaneously receives the first positioning data P1 and the first image data I transmitted by the first electronic device 21.

In detail, according to the first receiving mode in the embodiment, after the second transceiving module 221 simultaneously receives the first positioning data P1 and the first image data I, the second electronic device 22a instantly reads a longitude and latitude coordinate or a map data of the first positioning data P1. When the second electronic device 22a is moved to the location corresponding to the first positioning data P1, i.e. a processing module 224 determines that a second positioning data P2 matches the first positioning data P1, the second electronic device 22a reads the first image data I and projects the first image data I on a surrounding environment, such as a wall, a platy object, or other environments via the second projection module 222. However, if the processing module 224 determines that the second positioning data P2 does not match the first positioning data P1, i.e. the second electronic device 22a is not located at the location corresponding to the first positioning data P1, the second electronic device 22a fails to read the first image data I.

In the embodiment of the second receiving mode, after the second transceiving module 221 first receives the first positioning data P1, and the second electronic device 22a is moved to the location corresponding to the first positioning data P1, i.e. the processing module 224 determines that the second positioning data P2 matches the first positioning data P1, the second transceiving module 221 receives the first image data I, and the second projection module 222 reads the first image data I and projects the first image data I. In other words, the second transceiving module 221 of the second electronic device 22a first receives the first positioning data P1 and instantly reads the longitude and latitude coordinate or the map data of the first positioning data P1. Then, the receiver holds and moves the second electronic device 22a to the location corresponding to the first positioning data P1 according to the longitude and latitude coordinate or the map data of the first positioning data P1 until the second positioning data P2 matches the first positioning data P1. At that moment, the second transceiving module 221 may receive the first image data I transmitted by the first electronic device 21 and can read the first image data I. Then, the receiver can allow the first image data I to be projected on the surrounding environment, such as a wall, a platy object, or other environments, via the second projection module 222. If the second positioning data P2 of the second electronic device 22a does not match the first positioning data P1, i.e. the second electronic device 22a is not located at the location corresponding to the first positioning data P1, the second electronic device 22a fails to receive the first image data I.

In the embodiment, the second projection module 222 may also project the second image data on the surrounding environment. In addition, the second transceiving module 221 also transmit a second message including the second positioning data P2 and the second image data or the first message including the first positioning data P1 and the first image data Ito other electronic devices.

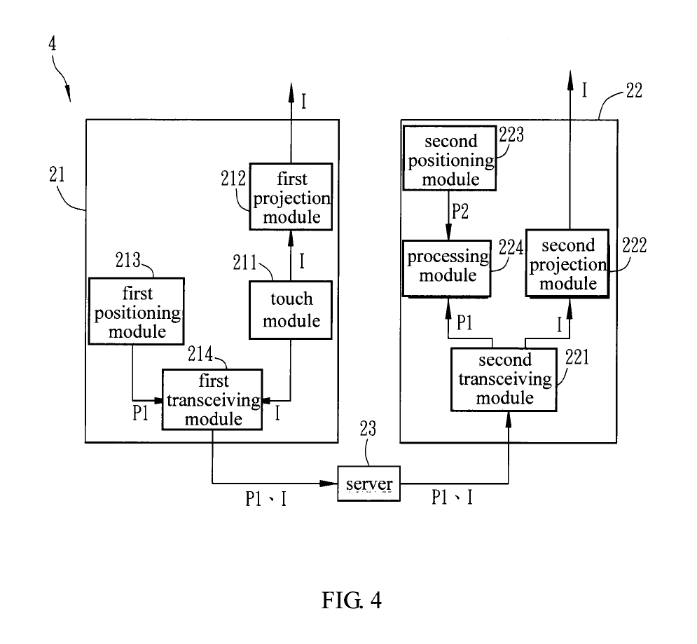

FIG. 4 is a schematic diagram showing a system for displaying a message according to one preferred embodiment of the invention. In the embodiment, a system 4 for displaying a message further includes a server 23, and the server 23 is coupled with a first electronic device 21 and a second electronic device 22. The server 23 receives a first positioning data P1 and a first image data I of the first electronic device 21 in a wireless transmission mode. The server 23 also simultaneously or nonsimultaneously transmits the first positioning data P1 and the first image data Ito the second electronic device 22 in a wireless transmission mode.

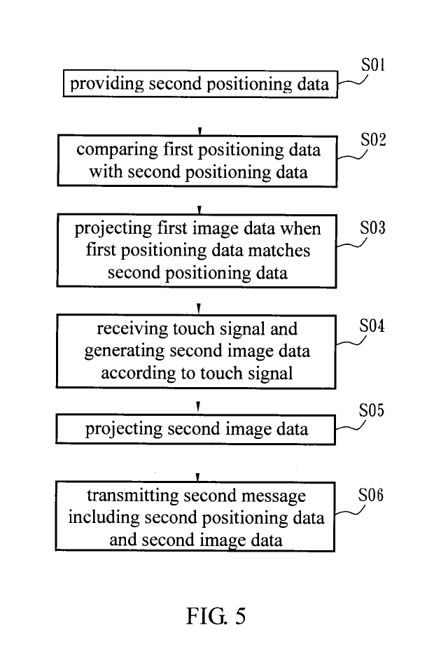

FIG. 5 is a flowchart showing a method for displaying a message according to one preferred embodiment of the invention. In the embodiment, the method for displaying a message is used for displaying a first image data of a first message, and the first message includes a first positioning data and the first image data. The method for displaying a message includes step S01 to step S03.

In FIG. 1 and FIG. 5, in step S01, a second positioning data P2 is provided. In step S02, a first positioning data P1 is compared with the second positioning data P2. In step S03, when the first positioning data P1 matches the second positioning data P2, a first image data I is projected.

In addition, the method for displaying a message in the embodiment further includes step S04 to step S06. However, the invention is not limited thereto. In step S04, a touch signal is received and a second image data is generated according to the touch signal. In step S05, the second image data is projected. In step S06, a second message including the second positioning data P2 and the second image data is transmitted.

According to the above embodiment, the method for displaying a message in the embodiment further includes the steps of determining whether the second positioning data P2 is substantially equal to the first positioning data P1 by a second electronic device 22, capturing an image data at a location of a first electronic device 21 by the first electronic device 21, and transmitting the image data to the second electronic device 22 by the first electronic device 21.

The method for displaying a message in the embodiment is described in detail according to the system for displaying a message 2 shown in FIG. 1. Therefore, it is not described for a concise purpose.

This invention further discloses a message-displaying device for displaying a first image data of a first message. The first message includes a first positioning data and the first image data. The device for displaying a message includes a projection module, a positioning module, and a processing module. The projection module is used for projecting the first image data; the positioning module provides a second positioning data according to a location of the device for displaying a message; the processing module is used for comparing the first positioning data and the second positioning data. When the first positioning data matches the second positioning data, the projection module projects the first image data.

In addition, the device for displaying a message in the embodiment of the invention further includes a touch module and a transceiving module. The touch module receives a touch signal and generates a second image data according to a touch signal; the transceiving module is used for receiving the first message and transmitting a second message including the second positioning data and the second image data.

In the embodiment, the device for displaying a message may be the first electronic device or the second electronic device in the above embodiment. The features and operating modes of the touch module, the projection module, the positioning module, and the transceiving module are described in detail in the above embodiments. Therefore, they are not described for a concise purpose.

To sum up, this invention discloses a system, a device, and a method for displaying a message. The first electronic device, i.e. a transmitting terminal, generates a first image data, such as photograph scrawl, drawing scrawl, or a text message and so on, according to a touch signal inputted by a user at the touch module and generates a first positioning data according to a location where the first electronic device generates the first image data. Therefore, besides using the first projection module of the first electronic device to project the first image data, the user may also transmit the first image data and the first positioning data to the second electronic device, a receiving terminal, in a wireless transmission mode, such that the first image data is played after a specific person reaches the location corresponding to the first positioning data. That is, the specific person cannot see the first image data until he or she substantially stays at the place where the first electronic device generates the first image data, thereby allowing the specific message to be expressed at the specific place.

Thereby, since the first image data is presented in a projection mode, the first image data is lively and interestingly presented, and an environment landscape is prevented from being damaged. In addition, a place where the first image data is projected is assigned via the first positioning data, further to combine the first image data and the surrounding environment to generate more changes.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A message-displaying method for displaying a first image data of a first message, the first message including a first positioning data and the first image data, the method comprising the following steps of:
providing a second positioning data;
comparing the first positioning data with the second positioning data; and
projecting the first image data when the first positioning data matching the second positioning data.

2. The method for displaying a message according to claim 1, further comprising the following steps of:
receiving a touch signal and generating a second image data according to the touch signal;
projecting the second image data; and
transmitting a second message including the second positioning data and the second image data.

3. A message-displaying device for displaying a first image data of a first message, the first message including a first positioning data and the first image data, the device comprising:
a projection module for projecting the first image data;
a positioning module providing a second positioning data according to a location of the device for displaying a message; and
a processing module for comparing the first positioning data with the second positioning data,
wherein when the first positioning data matches the second positioning data, the projection module projects the first image data.

4. The device for displaying a message according to claim 3, further comprising a touch module receiving a touch signal and generating a second image data according to the touch signal.

5. The device for displaying a message according to claim 3, further comprising a transceiving module for receiving the first message and transmitting a second message including the second positioning data and the second image data.

6. The device for displaying a message according to claim 5, wherein the device for displaying a message further comprises an image capturing module, and the image capturing module captures an image data at the location of the device for displaying a message.

7. The device for displaying a message according to claim 6, wherein the transceiving module of the device for displaying a message transmits the image data.

8. A system for displaying a message comprising:
a first electronic device including:
a touch module receiving a touch signal and generating a first image data according to the touch signal;
a first projection module for projecting the first image data;
a first positioning module providing a first positioning data according to a location of the first electronic device; and
a first transceiving module for transmitting a first message including the first positioning data and the first image data; and
a second electronic device including:
a second transceiving module for receiving the first message;
a second projection module for projecting the first image data; and
a second positioning module providing a second positioning data according to a location of the second electronic device, when the first positioning data matches the second positioning data, the second projection module projecting the first image data.

9. The system for displaying a message according to claim 8, wherein the second transceiving module first receives the first positioning data, and when the second electronic device is moved to the location corresponding to the first positioning data, the second transceiving module receives the first image data, and the second projection module projects the first image data.

10. The system for displaying a message according to claim 8, wherein the second transceiving module simultaneously receives the first positioning data and the first image data, and when the second electronic device is moved to the location corresponding to the first positioning data, the second projection module projects the first image data.

11. The system for displaying a message according to claim 8, further comprising:
a server receiving and transmitting the first positioning data and the first image data to the second electronic device.

12. The system for displaying a message according to claim 8, wherein the first electronic device further comprises an image capturing module, and the image capturing module captures an image data at the location of the first electronic device.

13. The system for displaying a message according to claim 12, wherein the first transceiving module transmits the image data to the second electronic device.
